(19) United States
(12) Patent Application Publication
(10) Pub. No.: US 2015/0153216 A1
(43) Pub. Date: Jun. 4, 2015

(54) VEHICLE WEIGHT CALCULATION DEVICE, WAVY ROAD, AND VEHICLE WEIGHT CALCULATION METHOD

(71) Applicant: Panasonic Intellectual Property Management Co., Ltd., Osaka (JP)

(72) Inventors: Tomoaki Abe, Kanagawa (JP); Makoto Otsuki, Kanagawa (JP)

(73) Assignee: Panasonic Intellectual Property Management Co.,Ltd, Osaka (JP)

(21) Appl. No.: 14/418,657

(22) PCT Filed: Jul. 5, 2013
(86) PCT No.: PCT/JP2013/004199

§ 371 Date: Jan. 30, 2015

(30) Foreign Application Priority Data
Aug. 1, 2012 (JP) 2012-170782

(51) Int. Cl. G01G 19/08

(52) U.S. Cl. CPC G01G 19/08

(57) ABSTRACT

The purpose of the present invention is to make it possible to reduce the computation load for calculating vehicle weight and to allow vehicle weight to be computed with little error. Provided is a vehicle weight calculation device (10) that calculates the weight of a vehicle (1) and is provided with a storage unit (105) for associating and storing position information and angular frequencies of a wavy road, and a control unit (101) for computing the weight of the vehicle (1). The control unit (101) computes the weight of the vehicle (1) on the basis of the vertical acceleration of the vehicle (1) and the angular frequency of the wavy road corresponding to the current position of the vehicle (1) as stored by the storage unit (105).

### TECHNICAL FIELD

The present invention relates to a vehicle weight calculation apparatus, a bumpy road and a vehicle weight calculation method capable of calculating a weight of a vehicle (hereinafter referred to as “vehicle weight”).

### BACKGROUND ART

Among conventional vehicle weight calculation apparatuses, there is one that estimates a weight of a vehicle being driven on a road with varying inclination and generates estimate values of the vehicle weight through a recursive process using data including variables indicating the vehicle speed and a longitudinal force acting on the vehicle, and a statistical filter using statistical representation of an inclination of the road (e.g., PTL 1).

### CITATION LIST

### Patent Literature

PTL 1

Japanese Unexamined Patent Application Publication (Translation of PCT Application) No. 2005-500525

### SUMMARY OF INVENTION

### Technical Problem

However, since the technique described in PTL 1 uses the statistical filter, it involves a large calculation load for calculating estimate values of the vehicle weight and involves large errors in the estimate values of the vehicle weight.

An object of the present invention is to provide a vehicle weight calculation apparatus, a bumpy road and a vehicle weight calculation method that are capable of reducing the calculation load for calculating a vehicle weight without using any statistical filter and calculating the vehicle weight with fewer errors.

### Solution to Problem

The present invention provides a vehicle weight calculation apparatus that calculates a weight of a vehicle, including: a storage section that stores position information in association with an angular frequency of a bumpy road; and a control section that calculates the weight of the vehicle, in which: the control section calculates the weight of the vehicle based on acceleration of the vehicle in a vertical direction and the angular frequency of the bumpy road corresponding to a current position of the vehicle stored in the storage section.

The present invention provides a bumpy road formed to calculate a weight of a vehicle, in which the bumpy road is formed so as to be displaced at a predetermined angular frequency in a vertical direction of the vehicle.

The present invention provides a vehicle weight calculation method for calculating a weight of a vehicle, the method including calculating the weight of the vehicle based on acceleration of the vehicle in a vertical direction and an angular frequency of a bumpy road corresponding to a current position of the vehicle.

### Advantageous Effects of Invention

According to the present invention, the weight of the vehicle is calculated based on acceleration in the vertical direction of the vehicle and an angular frequency of a bumpy road corresponding to a current position of the vehicle stored in the storage section, which provides effects of calculating the vehicle weight without use of any statistical filter, reducing the calculation load in calculating the vehicle weight and enabling calculation of the vehicle weight with fewer errors.

### BRIEF DESCRIPTION OF DRAWINGS

FIG. 1 is a block diagram illustrating a vehicle weight calculation apparatus and a peripheral configuration thereof according to an embodiment of the present invention;

FIG. 2 is a diagram provided for describing functions of a three-axis acceleration sensor according to the embodiment of the present invention;

FIG. 3 is a flowchart illustrating an example of operation carried out by the vehicle weight calculation apparatus according to the embodiment of the present invention;

FIG. 4 is a diagram provided for describing a vibration model of the vehicle according to the embodiment of the present invention;

FIG. 5 is a diagram provided for describing a vibration model of the vehicle according to the embodiment of the present invention;

FIG. 6 is a diagram provided for describing a shape of a bumpy road according to the embodiment of the present invention; and

FIG. 7 is a diagram provided for describing a relationship between an angular frequency and acceleration of the bumpy road.

### DESCRIPTION OF EMBODIMENT

Hereinafter, an embodiment of the present invention will be described in detail with reference to the accompanying drawings. Among all the drawings provided for describing the embodiment, the same elements are assigned the same reference numerals in principle and duplicate description thereof will be omitted.

### Embodiment

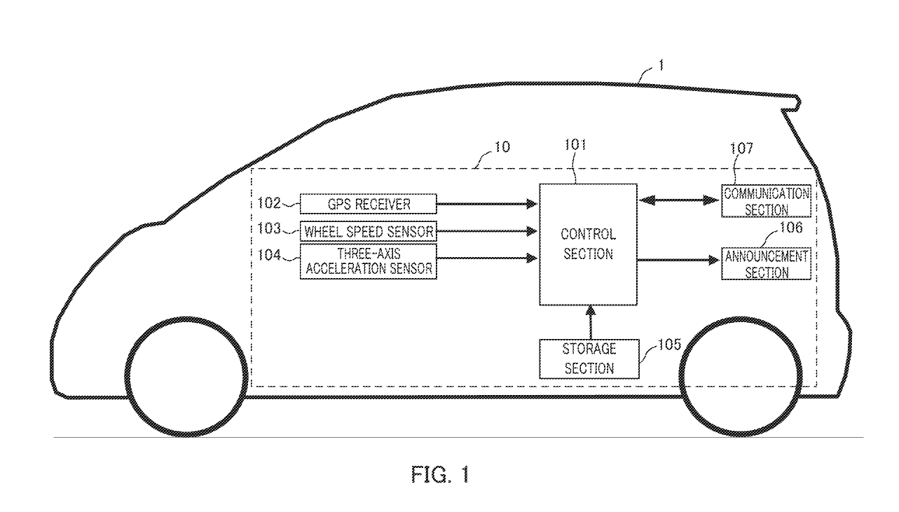

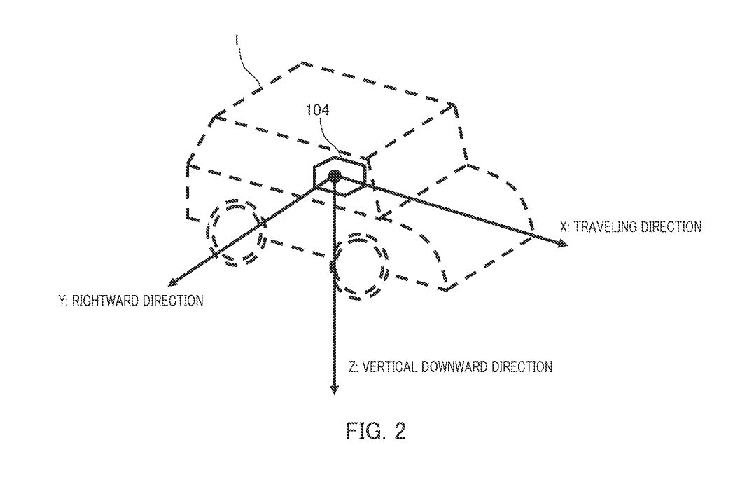

Each component of an embodiment of the present invention will be described with reference to FIG. 1 and FIG. 2. FIG. 1 is a block diagram illustrating a vehicle weight calculation apparatus and a peripheral configuration thereof according to the embodiment of the present invention. FIG. 2 is a diagram provided for describing functions of a three-axis acceleration sensor according to the embodiment of the present invention.

Vehicle weight calculation apparatus 10 is mounted on vehicle 1 and has a function of calculating a weight of vehicle 1 itself (vehicle weight). A road on which vehicle 1 runs is formed in advance as a bumpy road which is displaced at a predetermined angular frequency in a vertical direction of the vehicle. The term “bumpy” here refers to a sine wave shape. When vehicle 1 is running on this bumpy road, vehicle weight calculation apparatus 10 detects acceleration in the vertical direction of vehicle 1 and calculates the weight of vehicle 1 based on the angular frequency of the bumpy road and the detected acceleration.

More specifically, vehicle weight calculation apparatus 10 is provided with a storage section 105 that stores position information in association with the angular frequency of the bumpy road and control section 101 that calculates the weight of the vehicle, and control section 101 calculates the weight of vehicle 1 based on the acceleration in the vertical direction of vehicle 1 and the angular frequency of the bumpy road corresponding to the current position of vehicle 1 stored in storage section 105. Hereinafter, each section will be described in detail.

Control section 101 controls each section which will be described later, receives detection results of the sections and calculates the weight of vehicle 1.

GPS receiver 102 receives signals from a plurality of GPS (Global Positioning System) satellites, demodulates the received signals and can thereby acquire the current position of vehicle 1. The acquired current position of vehicle 1 is outputted to control section 101. That is, GPS receiver 102 corresponds to a current position acquiring section.

Wheel speed sensor 103 is a sensor that can detect a minute amount of rotation of a tire of vehicle 1 and outputs, for example, one detection pulse for every predetermined amount of rotation. Control section 101 can calculate the amount of travel of vehicle 1 by measuring the detection pulses outputted from wheel speed sensor 103. This amount of travel is as small as 4 centimeters, for example.

As shown in FIG. 2, three-axis acceleration sensor 104 is a sensor that detects acceleration in three mutually orthogonal axis directions. The accelerations in three axis directions refer to acceleration in traveling direction X of vehicle 1, acceleration in rightward direction Y and acceleration in vertical downward direction Z. The accelerations detected by three-axis acceleration sensor 104 are outputted to control section 101.

Storage section 105 is a storage medium such as a flash memory or hard disk. Storage section 105 stores information (hereinafter referred to as “road surface angular frequency information R) including position information of vehicle 1 associated with the angular frequency of the bumpy road. The position information is information on, for example, one latitude and longitude at which the bumpy road is located.

The angular frequency of the bumpy road is an angular frequency corresponding to displacement of the bumpy road in the vertical direction. The angular frequency of the bumpy road varies depending on the actual running speed of vehicle 1. A “direct distance on the road corresponding to one cycle of a sine shape” can be stored in storage section 105 as an “angular frequency of the bumpy road.” In this way, control section 101 can calculate the angular frequency of the bumpy road if the actual running speed of vehicle 1 can be acquired.

In addition, an “angular frequency at a predetermined speed” can alternatively be stored as an “angular frequency of the bumpy road.” Control section 101 can calculate the angular frequency of the bumpy road from a ratio between the predetermined speed and the actual running speed. That is, the “angular frequency of the bumpy road” may be a value which can be calculated from the actual running speed of vehicle 1.

The bumpy road formed to calculate the weight of the vehicle is formed at a predetermined position in advance. When calculating the vehicle weight using the angular frequency of the bumpy road, control section 101 needs to obtain the angular frequency of the bumpy road on which vehicle 1 is currently running Thus, storage section 105 stores information including position information of vehicle 1 associated with the angular frequency of the bumpy road.

As will be described later, storage section 105 also stores spring modulus k when a vibration model of vehicle 1 is modelled using a spring having spring modulus k. Storage section 105 also stores a maximum weight value of vehicle 1.

Announcement section 106 announces various kinds of information to occupants of vehicle 1 using sound information (speech, music or the like) or optical information (screen representation, blinking or the like, and is controlled by control section 101. More specifically, announcement section 106 is constructed of a speaker, display, LED or the like.

For example, when vehicle 1 is overloaded, announcement section 106 announces the overload to the occupants. Storage section 105 further stores a maximum weight of vehicle 1 and when the calculated weight of vehicle 1 is equal to or greater than the maximum weight of vehicle 1 stored in storage section 105, control section 101 controls announcement section 106 so as to announce the overload.

Communication section 107 is operated when vehicle 1 sends/receives various kinds of information to/from communication equipment (not shown) outside vehicle 1 and is controlled by control section 101. Communication section 107 can employ various communication schemes such as DSRC (Dedicated Short Range Communication).

<Operation of Vehicle Weight Calculation Apparatus 10>

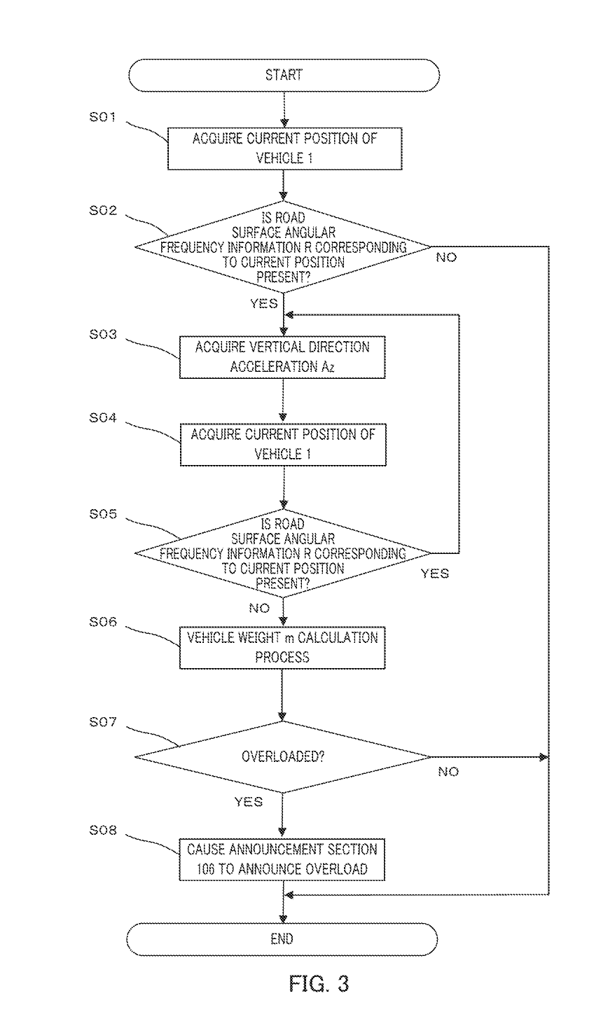

Operation of vehicle weight calculation apparatus 10 according to the embodiment of the present invention will be described with reference to FIG. 3. FIG. 3 is a flowchart illustrating an example of operation carried out by the vehicle weight calculation apparatus according to the embodiment of the present invention.

Control section 101 first acquires the current position from the output of GPS receiver 102 of vehicle 1 (S01) and determines whether or not storage section 105 stores road surface angular frequency information R corresponding to the current position (S02). When road surface angular frequency information R is not stored (NO in S02), control section 101 ends the process.

When storage section 105 stores road surface angular frequency information R (YES in S02), control section 101 acquires vertical direction acceleration Az from the output of three-axis acceleration sensor 104 (S03). Acquired vertical direction acceleration Az together with position information of the current position is stored in storage section 105.

Next, the current position is acquired again (S04), and it is determined whether or not road surface angular frequency information R is stored (S05). When storage section 105 stores road surface angular frequency information R (YES in S05), S03 is executed again.

When storage section 105 does not store road surface angular frequency information R (NO in S05), control section 101 performs a process of calculating weight m of vehicle 1 based on the position information stored in S03 and vertical direction acceleration Az (S06). Details of the process in S06 will be described later.

After calculating weight m of vehicle 1, control section 101 determines whether or not the vehicle is overloaded (S07). Control section 101 reads a maximum weight of vehicle 1 from storage section 105 and when calculated weight m of vehicle 1 is equal to or greater than the maximum weight, control section 101 determines that the vehicle is overloaded. When the vehicle is overloaded (YES in S07), control section 101 controls announcement section 106 so as to announce that the vehicle is overloaded using sound information or optical information. When the vehicle is not overloaded (NO in S07), control section 101 ends the process.

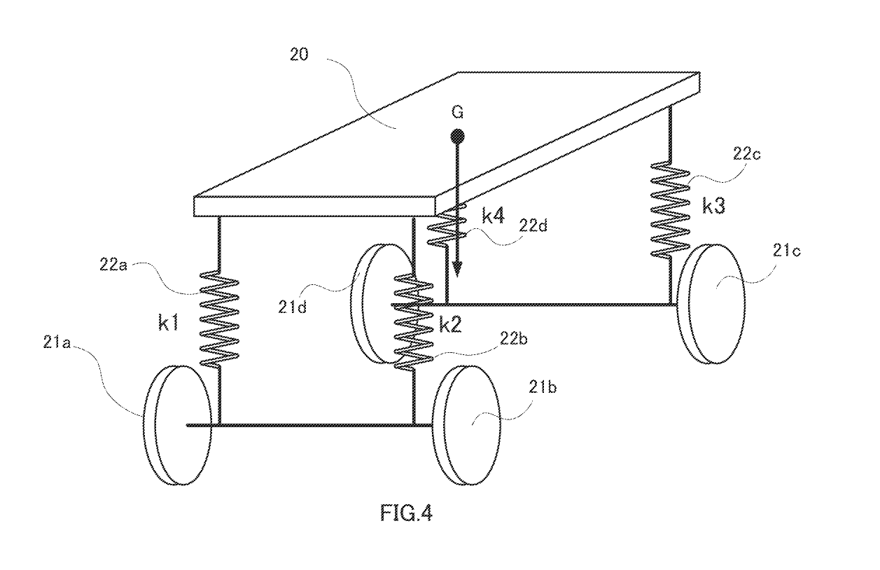

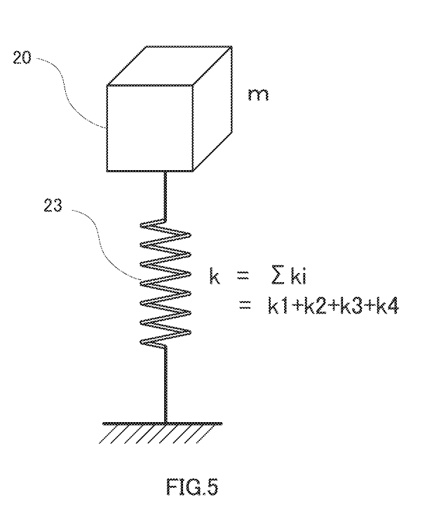

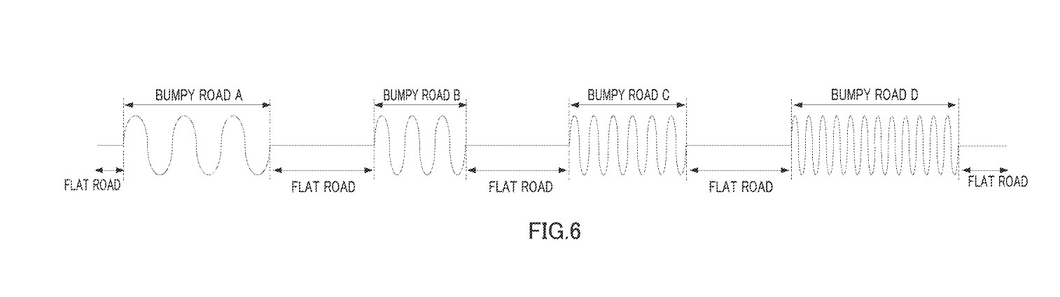

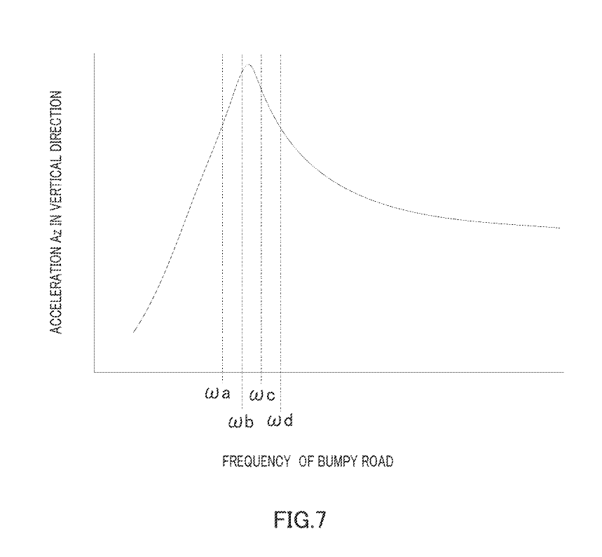

Next, an example of the process of calculating vehicle weight m shown in S06 in FIG. 3 will be described in detail using FIG. 4 to FIG. 6. FIG. 4 and FIG. 5 are provided for describing a vibration model of the vehicle according to the embodiment of the present invention. FIG. 6 illustrates the shape of the bumpy road according to the embodiment of the present invention and FIG. 7 illustrates a relationship between the angular frequency and acceleration of the bumpy road.

As shown in FIG. 4, vehicle 1 can be represented by a model with body 20 connected to wheel 21a, wheel 21b, wheel 21c and wheel 21d via spring 22a, spring 22b, spring 22c and spring 22d. Springs 22a, 22b, 22c and 22d equivalently represent elastic forces of suspensions or tires. Here, spring moduli of springs 22a, 22b, 22c and 22d are k1, k2, k3 and k4 respectively.

The model shown in FIG. 4 can be simplified and expressed by a model shown in FIG. 5. The model in FIG. 5 represents vehicle 1 in FIG. 4 as being connected to ground via one spring (combined spring 23) at center of gravity G. Spring modulus k of combined spring 23 is the sum (k1+k2+k3+k4) of spring moduli of springs 22a to 22d.

According to Hooke's law, natural angular frequency ωk of the model in FIG. 5 can be represented by:

Natural angular frequency ωk=√(spring modulus k/vehicle weight m) (Equation 1)

Equation 1 can be transformed into:

Vehicle weight m=spring modulus k/(natural angular frequency ωk)̂2 (Equation 2)

Spring modulus k is a value specific to vehicle 1 and is stored in storage section 105 in advance. That is, if natural angular frequency ωk is calculated, vehicle weight m can be calculated.

The running of vehicle 1 on the bumpy road displaced at a predetermined angular frequency in the vertical direction is equivalent to forcibly vibrating the springs with spring modulus k shown in FIG. 4 by applying a sine-function-like external force to the springs.

An equation of motion when displacement of combined spring 23 is X and a sine-function-like external force is added is:

Vehicle weight m*X″=spring modulus k+S*sin(ωt) (Equation 3)

where S is an amplitude of an external force given from the bumpy road.

The form of the solution to the equation of motion of forced vibration expressed by (Equation 3), in which attenuation by friction, air resistance and the like are not considered is:

X=(S/m)/(ωk̂2−ω̂2)*sin(ωt) (Equation 4)

When acceleration of X is calculated from equation 4,

X″=(S/m)*(ω̂2)/(ω̂2−ωk̂2)*sin(ωt) (Equation 5)

It can be understood by equation 5 that the acceleration (vertical direction acceleration Az) becomes a maximum (infinite) when ω coincides with natural angular frequency ωk. In reality, however, due to various attenuation factors, Az never becomes infinite even if ω coincides with natural angular frequency ωk.

Next, the formation of the bumpy road will be described. As shown in FIG. 6, the road on which vehicle 1 runs is formed as a bumpy road displaced in the vertical direction of vehicle 1 at a predetermined angular frequency. This bumpy road is formed to calculate the weight of vehicle 1. Vehicle 1 is intended to run from bumpy road A to bumpy road D at a constant speed.

The bumpy road is divided into a plurality of sections as shown in FIG. 6 and formed so as to be displaced at a plurality of different angular frequencies. The reason that the bumpy road is divided into a plurality of sections will be described later.

As shown in FIG. 6, on the bumpy road, a flat road is formed between a section displaced at a predetermined angular frequency and a section displaced at a different predetermined angular frequency. For example, as shown in FIG. 6, flat roads are located before bumpy road A, between bumpy roads A and B, B and C, C and D, and after bumpy road D. Vehicle 1 that has run on bumpy road A vibrates at the angular frequency of the bumpy road A. If vehicle 1 runs on bumpy road B immediately after this, influences of bumpy road A may remain. Thus, by providing the flat roads between the sections of the bumpy road, it is possible to weaken vibration of vehicle 1 and reduce influences of the bumpy roads with different angular frequencies.

Next, a method of calculating natural angular frequency ωk from the angular frequency of the bumpy road with reference to FIG. 7.

Regarding ωa to cod shown in FIG. 7, ωa is an angular frequency of bumpy road A, ωb is an angular frequency of bumpy road B, ωc is an angular frequency of bumpy road C and ωd is an angular frequency of bumpy road D.

The relationship between the angular frequency and acceleration of the bumpy road is represented by a waveform in which acceleration becomes a maximum at natural angular frequency ωk as shown in FIG. 7. This is also consistent with above equation 5.

Natural angular frequency ωk varies depending on weight m of vehicle 1. As shown in FIG. 7, control section 101 can estimate the shape of waveform by detecting each vertical direction acceleration Az at the plurality of angular frequencies (ωa to ωd) of the bumpy roads. If the waveform shape can be estimated, it is possible to accurately estimate natural angular frequency ωk at which acceleration becomes maximum.

In the case of FIG. 7, it is possible to estimate that natural angular frequency ωk is between ωb and ωc. Various methods can be adopted as the method of estimating natural angular frequency ωk.

Thus, by dividing the bumpy road into a plurality of sections and forming the sections so as to be displaced at a plurality of frequencies differing from one section to another, it is possible to estimate natural angular frequency ωk with a small calculation load. If natural angular frequency ωk can be calculated, it is possible to calculate weight m of vehicle 1 as shown in above equation 2.

### Effects of Present Embodiment

The present embodiment calculates the weight of vehicle 1 based on the acceleration of vehicle 1 in the vertical direction detected by three-axis acceleration sensor 104 and the angular frequency of the bumpy road corresponding to the current position of vehicle 1 stored in storage section 105, and can thereby provide effects of calculating the vehicle weight without use of any statistical filter, reducing a calculation load of calculating the vehicle weight and enabling calculation of the vehicle weight with fewer errors.

<Variations>

Although the present embodiment has modelled a vibration model of the vehicle using one-degree-of-freedom system, but the vibration model is not limited to this. For example, the vibration model may be modelled in a two-degree-of-freedom system in which tires and suspensions are assumed to be separate springs. In addition, the vibration model may be modelled in a four-degree-of-freedom system in which front wheel and back wheel tires and suspensions are assumed to be separate springs.

In S01 and S04 in FIG. 3, the current position of vehicle 1 is acquired by GPS receiver 102, but if there is a problem with accuracy, detailed positional adjustment may be performed using wheel speed sensor 103. Other position detection methods can also be used.

The acquisition of the current position of vehicle 1 in S01 and S04 in FIG. 3 may be performed by communication section 107 by DSRC. Since DSRC has a short-range communication area, it is possible to provide a detailed position of vehicle 1.

A case has been described in the present embodiment where vehicle weight calculation apparatus 10 mounted on vehicle 1 calculates a vehicle weight, but communication section 107 may transmit position information of vehicle 1 and acquired vertical direction acceleration Az so that the vehicle weight may be calculated outside vehicle 1.

A case has been described where when vehicle 1 is overloaded, announcement section 106 mounted on vehicle 1 announces the overload (S08 in FIG. 3), but this announcement section can also be installed outside vehicle 1. The overload may be announced to occupants of vehicle 1 from an electric bulletin board or the like installed outside vehicle 1.

Road surface angular frequency information R stored in storage section 105 may be stored in advance before vehicle 1 starts running or may be received via communication section 107 and stored during running.

The present embodiment has illustrated announcement of overload as an application of calculation results of vehicle weight m, but there can be a variety of applications in addition to such an application.

In the foregoing embodiments, the present invention is configured with hardware by way of example, but the invention may also be provided by software in cooperation with hardware. The functional blocks used in the descriptions of the embodiments are typically implemented as LSI devices, which are integrated circuits. The functional blocks may be formed as individual chips, or a part or all of the functional blocks may be integrated into a single chip. The term “LSI” is used herein, but the terms “IC,” “system LSI,” “super LSI” or “ultra LSI” may be used as well depending on the level of integration.

In addition, the circuit integration is not limited to LSI and may be achieved by dedicated circuitry or a general-purpose processor other than an LSI. After fabrication of LSI, a field programmable gate array (FPGA), which is programmable, or a reconfigurable processor which allows reconfiguration of connections and settings of circuit cells in LSI may be used.

Should a circuit integration technology replacing LSI appear as a result of advancements in semiconductor technology or other technologies derived from the technology, the functional blocks could be integrated using such a technology. Another possibility is the application of biotechnology and/or the like.

The disclosure of the specification, drawings and abstract in Japanese Patent Application No. 2012-170782 filed on Aug. 1, 2012 is incorporated herein by reference in its entirety.

### INDUSTRIAL APPLICABILITY

The vehicle weight calculation apparatus and the vehicle weight calculation method according to the present invention are suitable for use in a vehicle or the like whose weight needs to be calculated.

### REFERENCE SIGNS LIST

1 Vehicle
10 Vehicle weight calculation apparatus
101 Control section
102 GPS receiver (current position acquiring section)
103 Wheel speed sensor
104 Three-axis acceleration sensor
105 Storage section
106 Announcement section
107 Communication section
20 Body
21a, 21b, 21c, 21d Wheel
22a, 22b, 22c, 22d Spring
23 Combined spring

1. A vehicle weight calculation apparatus that calculates a weight of a vehicle, the apparatus comprising:
a storage section that stores position information and an angular frequency of a bumpy road in association with each other; and
a control section that calculates the weight of the vehicle, wherein
the control section calculates the weight of the vehicle based on acceleration of the vehicle in a vertical direction and the angular frequency of the bumpy road corresponding to a current position of the vehicle stored in the storage section.

2. The vehicle weight calculation apparatus according to claim 1, wherein the control section calculates the weight of the vehicle based on a plurality of different angular frequencies of the bumpy road stored in the storage section and a plurality of accelerations of the vehicle in the vertical direction.

3. The vehicle weight calculation apparatus according to claim 1, wherein the angular frequency of the bumpy road corresponding to the current position of the vehicle stored in the storage section is an angular frequency corresponding to displacement of the bumpy road in the vertical direction of the vehicle.

4. The vehicle weight calculation apparatus according to claim 2, wherein
the storage section stores spring modulus k when a vibration model of the vehicle is modelled by a spring having spring modulus k, and
the control section calculates natural angular frequency ωk of the spring from the plurality of different angular frequencies of the bumpy road stored in the storage section and the plurality of accelerations of the vehicle in the vertical direction, and calculates the weight of the vehicle as a product of spring modulus k stored in the storage section and a square of the natural angular frequency ωk.

5. The vehicle weight calculation apparatus according to claim 1, further comprising an announcement section that is controlled by the control section and that announces that the vehicle is overloaded using sound information or optical information, wherein:
the storage section further stores a maximum weight of the vehicle; and
when the calculated weight of the vehicle is equal to or greater than the maximum weight of the vehicle stored in the storage section, the control section controls the announcement section so as to announce the overload.

6. The vehicle weight calculation apparatus according to claim 1, further comprising:
an acceleration sensor that detects acceleration of the vehicle in the vertical direction and that outputs the acceleration to the control section; and
a current position acquiring section that detects a current position of the vehicle and outputs the current position to the control section.

7. A bumpy road formed to calculate a weight of a vehicle, wherein the bumpy road is formed so as to be displaced at a predetermined angular frequency in a vertical direction of the vehicle.

8. The bumpy road according to claim 7, wherein the bumpy road is divided into a plurality of sections and formed so as to be displaced at a plurality of angular frequencies differing from one section to another.

9. The bumpy road according to claim 8, wherein the bumpy road comprises a flat road formed between a section being displaced at a predetermined angular frequency and a section being displaced at a different predetermined angular frequency.

10. A vehicle weight calculation method for calculating a weight of a vehicle, the method comprising calculating the weight of the vehicle based on acceleration of the vehicle in a vertical direction and an angular frequency of a bumpy road corresponding to a current position of the vehicle.

11. The vehicle weight calculation method according to claim 10, wherein the weight of the vehicle is calculated based on a plurality of accelerations of the vehicle in the vertical direction and a plurality of different angular frequencies of the bumpy road.

12. The vehicle weight calculation method according to claim 10, wherein the angular frequency of the bumpy road corresponding to the current position of the vehicle is an angular frequency corresponding to displacement of the bumpy road in the vertical direction of the vehicle.

13. The vehicle weight calculation method according to claim 11, wherein a vibration model of the vehicle is modelled by a spring having spring modulus k, natural angular frequency ωk of the spring is calculated from the plurality of different angular frequencies of the bumpy road and a plurality of accelerations of the vehicle in the vertical direction, and a product of spring modulus k and a square of the natural angular frequency ωk is calculated as the weight of the vehicle.
